(19) United States
(12) Patent Application Publication
(10) Pub. No.: US 2004/0172380 A1
(43) Pub. Date: Sep. 2, 2004

(54) Automatic cooking method and system

(76) Inventors: Xiaolin Zhang, Yokohama (JP); Guangrong Zhang, Shanghai (CN)

Correspondence Address: QIN ZHANG, Suite 300, 12304 Santa Monica Blvd., West Los Angeles, CA, 90025, US

(21) Appl. No.: 10/794,654

(22) Filed: Mar. 8, 2004

Related U.S. Application Data
(63) Continuation of application No. PCT/CN02/00665, filed on Sep. 18, 2002.

(30) Foreign Application Priority Data
Sep. 29, 2001 (CN) 01126933.2

(51) Int. Cl. G06F 7/00

(52) U.S. Cl. 707/1

(57) ABSTRACT

The present invention provides an automatic cooking method and system, wherein the cooking process of a chef is recorded. Then, a program about the cooking process is obtained with information about amounts and kinds of main ingredients and seasoning materials used by the chef, timing of adding main ingredients and seasoning materials and movement tracks of the cooking container and shovel. Thereafter, manipulators of a mechanical operating system of the present invention imitate chef's cooking process according to commend signal from the program to produce a dish. The present invention uses recording devices to record chef's cooking process and provide a program, then respective mechanical operating system accomplishes cooking tasks imitating the chef, which provides restaurants and households with dishes by the chef when using the program and mechanical operating system. The present invention not only made exceptional dishes widely available, it can also serve a large number of patrons at the same time

### FIELD OF THE INVENTION

This application is a continuation in part of the PCT application PCT/CN02/00665 filed on Sep. 18th, 2002. The present invention relates generally to an automatic cooking method and system, and more particularly to a method and system of recording and simulating a cooking process for a dish by a famous chef.

### BACKGROUND OF THE INVENTION

Traditionally, cooking is done by chefs one dish at a time. Exceptional dishes sometimes can only be produced by a limited number of famous chefs. Therefore, certain dishes cannot be provided unless a particular chef is invited to a restaurant. For example, Chinese cuisine has many types of cooking styles. For each style there are only limited numbers of chefs who are capable of producing certain exceptional dishes. In the past, the styles and crafts were passed on to the next generation individually, but this method has obvious limitations. It cannot serve a large number of patrons at the same time. The public is not well served by this method.

The objective of the present invention is to provide an automatic cooking method and system that will widely spread the unique techniques of the famous chefs.

### SUMMARY OF THE INVENTION

In order to achieve the objective of the present invention, the present invention provides an automatic cooking method including the following steps:

1). Measuring and recording kinds and amounts of main ingredients and seasoning materials prepared by a chef;

2). Measuring and recording movement tracks of cooking containers and shovels;

3). Measuring and recording amounts of main ingredients and seasoning materials added by the chef and timing when the main ingredients and seasoning materials are added;

4). Measuring and recording strength of fire adjusted by the chef and timing when strength of fire is adjusted;

5). Processing the data recorded by step 1 through step 4 by a computer and providing an operation program of the automatic cooking system that reflects the chef's cooking process;

6). Installing the operation program into the automatic cooking system and central control device, enabling the central control device to operate according to the operation program and to complete the cooking process.

Additionally, in order to achieve the objective of the present invention, the automatic cooking system provided by the present invention comprises recording system that records the chef's cooking process, and mechanical operation system that operates according to recorded cooking process, wherein said recording system comprises:

1). Equipment for measuring and recording kinds and amounts of main ingredients and seasoning materials prepared by a chef;

2). Equipment for measuring and recording amounts of main ingredients and seasoning materials added by the chef and timing that main ingredients and seasoning materials are added;

3). Equipment for measuring and recording movement tracks of cooking containers and shovels;

4). Equipment for recording and measuring strength of fire adjusted by the chef and timing when main ingredients and seasoning materials are added;

5). Equipment for processing recorded data, and for providing operation program of the automatic cooking system that reflects the chef's cooking process.

The mechanical operation system includes:

1). A controller installed with the operation program that reflects the chef's cooking process;

2). Manipulators that is adapted to be connected with the cooking containers and shovels, and complete the cooking tasks according to signals received from the operation program of the controller that reflect the chef's cooking process;

3). Fire controlling device that is connected with the stove, and control the strength of fire according to signals received from the operation program of the controller that reflect strength of stove controlled by the chef;

4). Main ingredient and seasoning material supply devices that is connected with the main ingredient and seasoning material supply equipment, and control the main ingredient and seasoning material supply equipment according to signals received from the operation program of the controller that reflect the kinds and amounts of the main ingredients and seasoning materials added by the chef and timing when the main ingredients and seasoning materials are added.

The present invention records the cooking process of the chef with recording system and provides operation program according to the cooking process, then it operates the mechanical operation system to complete cooking tasks. Thus, delicious dishes by famous chefs will be available to any restaurant or household who purchase the mechanical operation system and operation program. This will not only widely spread the technique for making those exceptional dishes, it will also save manpower.

### BRIEF DESCRIPTION OF THE DRAWINGS

FIG. 1 illustrates the recording system for recording the cooking process of a chef;

FIG. 2 illustrates the mechanical operating system of the automatic cooking system;

FIG. 3 illustrates the base coordinate system, camera lens coordinate system and cooking container and shovel coordinate systems;

FIG. 4 illustrates the positions of the specific points in camera lens coordinate system;

FIG. 5 illustrates the positions of the specific points at the camera receiving membrane;

FIG. 6 is the calculation of the position and posture of a cooking container based on the coordinates of the specified points at base coordinate system;

FIG. 7 is the block diagram of calculation of the movement track of the manipulators;

FIG. 8 illustrates the dynamic model of the manipulators;

FIG. 9 illustrates the dynamic model of allover components of the mechanical operating system of the automatic cooking system;

FIG. 10 is the electrical circuit drawing of the recording system that records the demo cooking process of the chef;

FIG. 11 is the electrical circuit drawing of mechanical operating system of the automatic cooking system;

FIG. 12 is the manipulator control diagram.

Illustrated below is the detailed description of the embodiment of present invention related to the Figures.

### DETAILED DESCRIPTION OF THE INVENTION

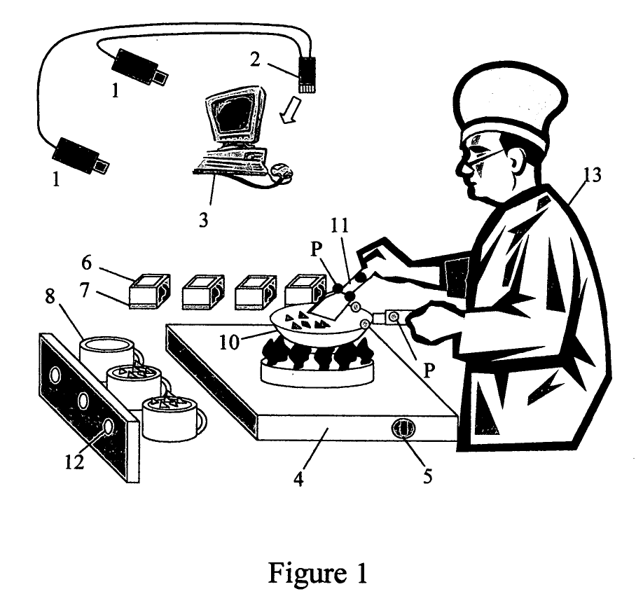

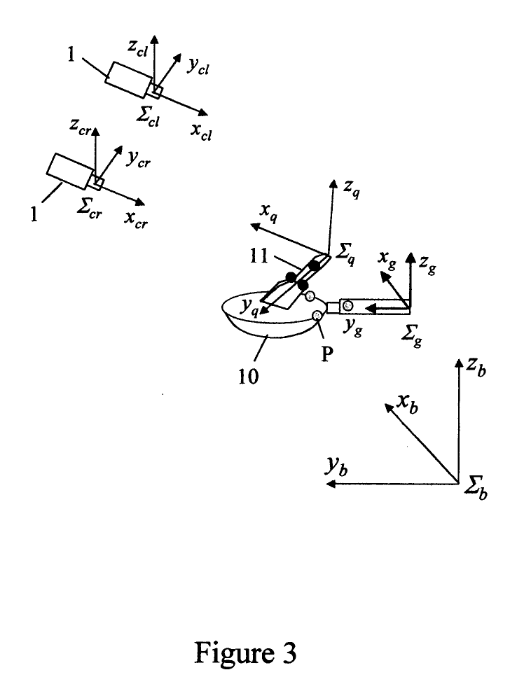

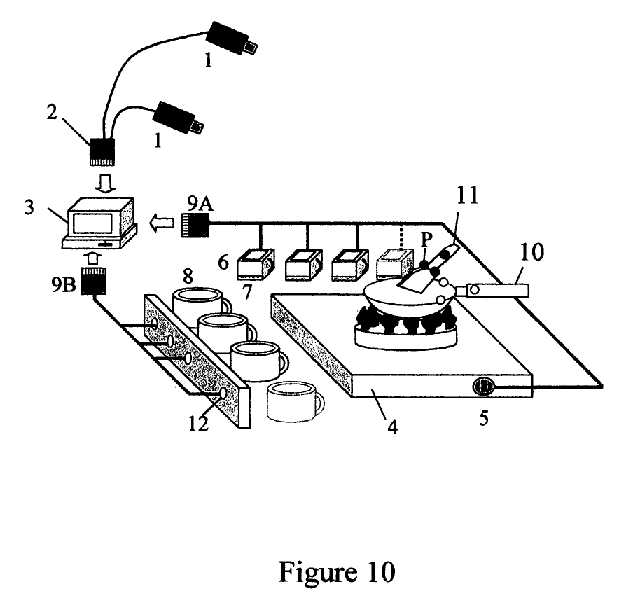

FIG. 1 illustrates the cooking process of a chef. As illustrated in FIG. 1, multiple (three were shown) main ingredient containers 8 are used to contain the main ingredients of the dish. Two cameras 1 record the cooking process conducted by the chef, said cameras 1 receive images of the cooking process conducted by the chef and send the signals to a computer 3. Said computer 3 processes the images. The computer 3 measures and calculates the coordinate system positions of each specified points P of cooking container (such as wok) 10 and shovel 11 during the movement in the cooking process (see FIG. 3), and obtain the movement track of cooking container 10 and shovel 11. Multiple (four were shown) seasoning material containers 6 contain seasoning materials such as cooking oil, salt, sauces, and vinegar, etc. An electronic scale 7 is placed under each seasoning material container 6 respectively, the electronic scales 7 measure the amounts of seasoning materials added to the cooking container 10 and transform the data to electronic signals. In the mean time, said electronic scales 7 also record the time when the seasoning materials are added. These data are transformed into numerical signals through first interfaces (such as A/D board, I/O port) 9A and sent to computer 3 (see FIG. 10). Therefore, the data for the amounts of seasoning materials added and the time when the seasoning materials are added will be stored in computer 3. The rotation sensor set in stove 4 will measure the rotated angle of stove rotating switch 5. Said rotation sensor will record the adjustment of the strength of stove by the chef, and simultaneously record the time when the adjustments are made. A temperature sensor (such as thermocouple thermograph) installed on the cooking container (such as wok or pot) can also measure the temperature of the cooking container to reflect the strength of the fire, the signal for the temperature will also be sent to computer 3. A position sensor (such as infrared transmitter, or touch on switch) 12 can also record the time when the main ingredients are put into the cooking container 10.

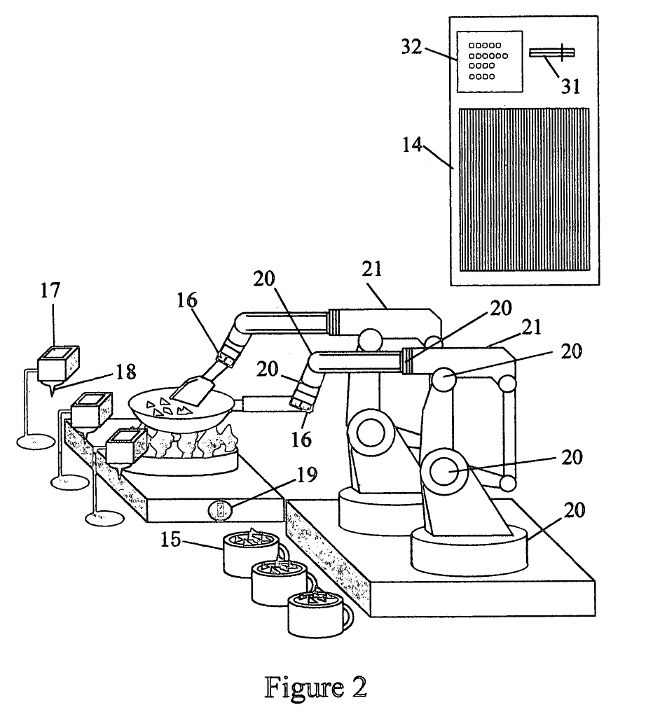

FIG. 2 illustrates the mechanical operating system of automatic cooking system. As shown, the present invention uses one or more manipulators and affiliating devices to construct mechanical operating system. The automatic cooking system comprises multiple, such as three, seasoning material containers 17, the output of which are controlled by a computer program and program controlled funnels 18 placed underneath that can add the seasoning materials for the dish according to operation commends of the program. Each manipulator 21 of the mechanical operating system has at least one mechanical hand 16, and has at least six degrees of freedom (i.e. has at least six joints 20). Said mechanical hands 16 can grab and hold multiple, such as three, main ingredient containers 15 that contain main ingredients of the dish and pull out the main ingredients according to the operation commends of the program. The stove switch 19 can control the fire strength of the stove according to operation commends of the program. The central controller 14 comprises exterior storage interface 31 and displayer 32. The exterior memory (such as diskette, CD, etc.) containing operation program is installed into central controller 14 (or the operation program is sent to central controller 14 through network). Once the main ingredients and seasoning materials for the dish are prepared according to the requirement of the operation program, said mechanical operating system will automatically start cooking once the operation program starts.

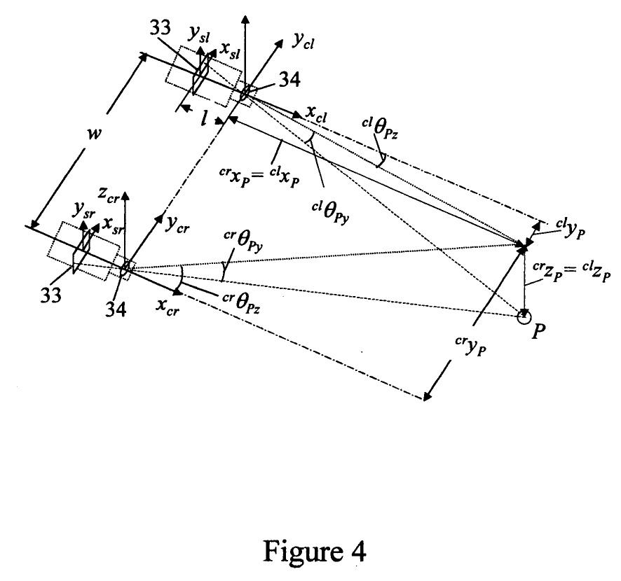

FIG. 3 illustrates the setup of base coordinate system Σ_{b}, camera lens coordinate system (Σ_{cl and} Σ_{cr}) and cookware coordinate system of the recording system. The base coordinate system Σ_{b} of the recording system is correspondence to the base coordinate system Σ_{b} of the mechanical operating system. Through this setup, the intended movement tracks of the cooking container 10 and shovel 11 can be obtained by the operation program. As shown in FIG. 3, two of the camera coordinate systems set at the centers of the lenses of the left and right cameras 1 respectively, and the positions of said two cameras and the positions of base coordinate system are directly related. Said camera coordinate systems are shown as Σ_{cl,} Σ_{cr} (also shown in FIG. 4). Two movement coordinate systems set at the tips of the handles of the cooking container 10 and shovel 11 are presented as Σ_{g,} Σ_{q}. The coordinate system positions of said cooking container 10 and shovel 11 directly relate to the coordinate positions of three specified points P (dots of same color). Calculations based on the images recorded by the cameras provide the relevant positions of the specified points to the camera coordinate systems, and the relevant positions of Σ_{g,} Σ_{q} to base coordinate system Σ_{b} can also be calculated. The details of the calculation are illustrated below.

As shown in FIG. 4, one specific point P is used as an example for the calculation, wherein camera 1 comprises image receiving membrane 33, camera lens 34. The axis center lines cr and cl of left and right cameras 1 are parallel with each other, and in line with said camera lens 34. The centers of lenses O_{cl} and O_{cr} are origins of the camera coordinate system, and the line connect them becomes Y axis of the camera (the Y axis of the left camera is y_{cl,} the Y axis of right camera is y_{cr}). The axis center lines of two cameras are X axis, wherein the X axis of left and right cameras is x_{cl, x}_{cr} respectively. The plane formed by x_{cl} and y_{cl} of the left camera are the same with the plane formed by x_{cr} and y_{cr.} Therefore, the left and right cameras' center lines are at the same plane. The z_{cl} and z_{cl} axis of the left and right cameras are perpendicular to this plane, which is called Z plane. The plane formed by y_{cl} and z_{cl} axis of the left camera must be the same as the plane formed by y_{cr} and z_{cr} axis of the right camera, that is the left and right camera are in line with each other. The plane formed by x_{cl} and z_{cl} axis of the left camera is parallel to the plane formed by x_{cr} and z_{cr} axis of the right camera, and distance between them is w, which is also the distance between the origins of the coordinate system O_{cl} and O_{cr.} The distances of point P in FIG. 4 to each plane at each moment are its positions at the left and right camera coordinate systems, shown as (^{cl}xₚ, ^{cl}y_{p,} ^{cl}zₚ, ^{cr}xₚ, ^{cr}yₚ, ^{cr}zₚ).The projection point from point P to plane Z is P_{z}. Connecting PO_{cl,} PO_{cr.}, and P_{z}O_{cl} and P_{z}O_{cr,} the angle between PO_{cl} and P_{z}O_{cl} is called ^{cl}θ_{Py}, the angle between PO_{cr} and P_{z}O_{cr} is called ^{cr}θ_{Py}, the angle between P_{z}O_{cl} and x_{cl} is called ^{cl}θ_{Pz}, the angle between P_{z}O_{cr} and x_{cr} is called ^{cr}θ_{Pz}, and the relationship between them can be calculated by the equation below, wherein ^{cl}, ^{cr} represent the coordinate systems of the left and right cameras:

^{cr}xₚtan ^{cr}θ_{Pz}=^{cr}yₚ

^{cl}xₚtan ^{cl}θ_{Pz}=^{cl}yₚ

Because ^{cl}xₚ=^{cr}xₚ, and ^{cl}yₚ+^{cr}yₚ=w,

^{cr}xₚ tan ^{cr}θ_{Pz}+^{cl}xₚ tan ^{cl}θ_{Pz}=w

^{cr}xₚ=^{cl}xₚ=w(cot ^{cr}θ_{Pz}+cot ^{cl}θ_{Pz})

^{cr}yₚ=^{cr}xₚ tan ^{cr}θ_{Pz,}^{cl}yₚ=^{cl}xₚ tan ^{cl}θ_{Pz}

$${}_{}^{cr}{z}{}_{p}^{} = {}_{}^{cl}{z}{}_{p}^{} = {}_{}^{cl}{x}{}_{p}^{} \frac{1}{sin {}_{}^{cl}{θ}{}_{Pz}^{}} tan {}_{}^{cl}{θ}{}_{Py}^{}$$

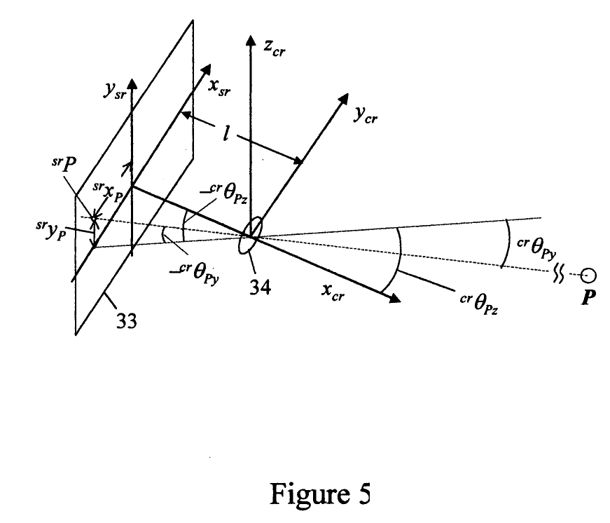

FIG. 5 illustrates how to use the positions of ^{sr}P (^{sr}xₚ, ^{sr}yₚ) (the measuring unit of which needs to be transformed from pixel into mm, the transformation ratios are different for different cameras) in the image received by image receiving membrane 33 of the right camera to obtain rotation angles (^{cr}θ_{Py}, ^{cr}θ_{Pz}). ^{sl}, ^{sr} represent the image receiving membrane plane coordinate system of the left and right cameras, and l is the distance between image receiving membrane and the center of the lens.

The equation for calculating the rotation angle is shown below:

$$\begin{matrix}{}_{}^{cr}{θ}{}_{Pz}^{} = - {tan}^{- 1} \frac{{}_{}^{sr}{x}{}_{p}^{}}{l} \\ {}_{}^{cr}{θ}{}_{Py}^{} = - {tan}^{- 1} \frac{{}_{}^{sr}{y}{}_{p}^{} cos {}_{}^{cr}{θ}{}_{Pz}^{}}{l}\end{matrix}$$

^{cl}θ_{Pz} and ^{cl}θ_{Py} can also be calculated from ^{sl}xₚ and ^{sl}yₚ of left camera using the same method.

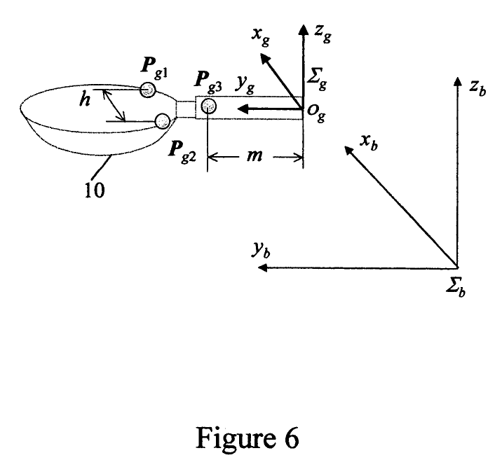

FIG. 6 illustrates how to use the positions of three specific points (^{b} [symbol] _{g1}, ^{b} [symbol] _{g2}, ^{b} [symbol] _{g3}) on the cooking container to calculate the related position (^{b} [symbol] _{g}) and posture (^{b} [symbol] _{g}) of the cooking container coordinate system Σ_{g} to the base coordinate system Σ_{b}. The position and posture Matrix of the cooking container (^{b} [symbol] _{g}) can be calculated as shown below:

^{b} [symbol] _{g1}=[^{b}x_{g1},^{b}y_{g1},^{b}z_{g1}]

^{b} [symbol] _{g2}=[^{b}x_{g2},^{b}y_{g2},^{b}z_{g2}]

^{b} [symbol] _{g3}=[^{b}x_{g3},^{b}y_{g3},^{b}z_{g3}]

$${}_{}^{b}{T}{}_{g}^{} = [ \begin{matrix}{}_{}^{b}{R}{}_{g}^{} & {}_{}^{b}{p}{}_{g}^{} \\ {0}^{T} & 1\end{matrix} ]$$

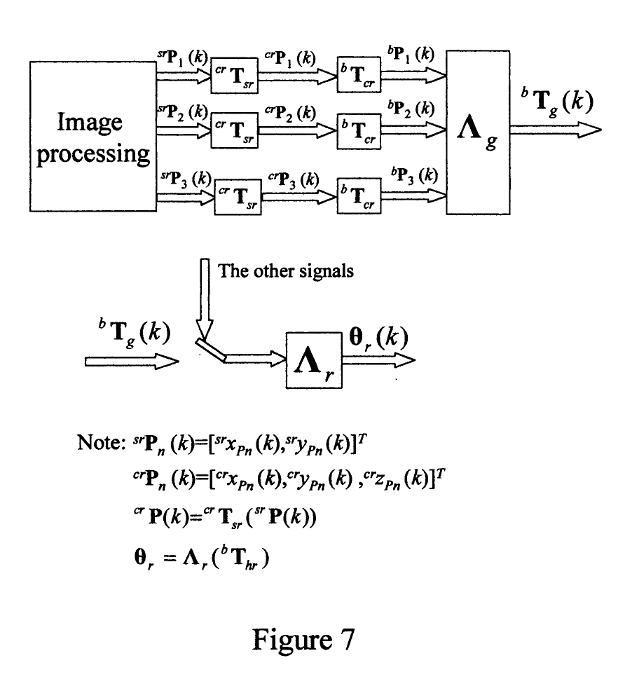

^{b} [symbol] _{g}= [symbol] _{g(}^{b}P_{g1},^{b}P_{g2,}^{b}P_{g3})

Wherein _{b} is the base coordinate system. ^{b}x_{g1} represents the distance of point P₁ on the cooking container 10 at base coordinate system Σ_{b} to plane y_{b}-z_{b}. Because camera coordinate system and base coordinate system has fixed relationship, ^{b} [symbol] _{gn} (n=1, 2, 3) may be obtained from (^{cr}x_{pg,} ^{cr}y_{pg}, ^{cr}z_{pg}) and (^{cl}x_{pg,} ^{cl}y_{pg}, ^{cl}z_{pg}) through coordinate transformation. [symbol] _{g} in the equation is linear algebra function. The function of [symbol] _{g} is obtained according to the setup of the cooking container coordinate system, and a person with ordinary skill in the art can obtain it according to a well known calculation method, which will be omitted here. The result of the above calculation will be shown at the block diagram of FIG. 7, wherein the calculation process in FIG. 7 is illustrated as follow: The coordinate positions of the three specified points (^{sr} [symbol] ₁, ^{sr} [symbol] ₂, ^{sr} [symbol] ₃ and ^{sl} [symbol] ₁, ^{sl} [symbol] ₂, ^{sl} [symbol] ₃) on the image receiving membrane plane coordinate systems (xₛᵣ−yₛᵣ and xₛₗ−yₛₗ) are obtained using computer image processing, then the coordinate position of each specified point (^{cr} [symbol] ₁, ^{cr} [symbol] ₂, ^{cr} [symbol] ₃ and ^{cl} [symbol] ₁, ^{cl} [symbol] ₂, ^{cl} [symbol] ₃) in each camera lens coordinate system (x_{cr}−y_{cr}−z_{cr} or x_{cl}−y_{cl}−z_{cl}) is calculated through coordinate transformation. Further, the coordinate position of each specified point related to base coordinate systems is calculated through coordinate transformation, and the relative position and posture of the cooking device coordinate system Σ_{g} to the base coordinate system Σ_{b,} refereed to as ^{b}T_{g}(k), are obtained, where k is the sample cycle number.

As shown in FIG. 7, “other action signals”, such as action signals indicating the action of taking the ingredients or adjusting the strength of the fire, are inserted. Because these actions are decided according to starting points and ending points, and the calculations are relatively simply, and a person of ordinary skill in the art will be able to calculate them easily, the calculation will be omitted here. Each manipulator has its own specific kinematics function, and [symbol] ᵣ is the kinematics function of the right manipulator. [symbol] ᵣ(k) is the rotation angle vector of each joint of the right manipulator (also called object track). The calculation process of the rotation angle vector of the each joint of the left manipulator is the same with the right manipulator, which will be omitted here. The calculation for shovel is the same as for the cooking container, which will also be omitted here.

Because the image processing process for the cooking process recording system is only used to identify some specified marks, ordinary image identification method such as Hough Transform can be used to calculate the position of each mark, which will not be discussed in detail here. Besides, the method of recording the cooking process illustrated above can also be replaced by Direct Teaching method often used in ordinary manipulator (the chef can use his/her arms to direct manipulators in order to directly teach the manipulator the movement for the cooking process), or replaced by Magnetic Field sensor (magnetic sensors can be used to record the positions of the cooking container and shovel in order to record the cooking process). However, the method illustrated here will be able to guarantee accuracy. In practice, these methods can compliment each other. The calculation and manipulator operating program are performed by computer automatically. The image processing and camera recording process may be conducted simultaneously, or the image processing task can be conducted after the images have been recorded.

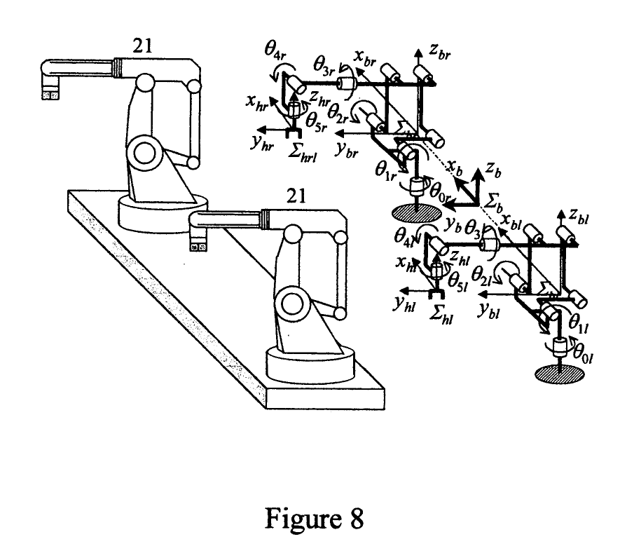

FIG. 8 is the structure and kinematics model of the manipulators of the automatic cooking system. As shown in FIG. 8, the structures of these manipulators are similar to the structure of ordinary manipulators for industrial use. θ₀ₗ,θ₂ₗ . . . θ₅ₗ and θ₀ᵣ, θ₁ᵣ . . . θ₅ᵣ represent the rotation angles of each of the six elbows of two manipulators.

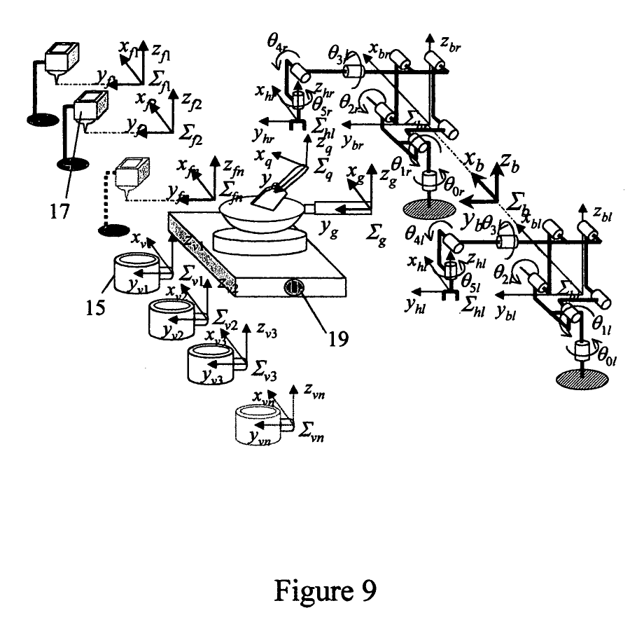

FIG. 9 is the kinematics model of all the components of the mechanical operation system of the automatic cooking system. The setups of the coordinate system are as follow: The setups of the coordinate systems of the cooking container and shovel (Σ_{g}, Σ_{q}) and the base coordinate system Σ_{b} are the same as those of the coordinate systems of the cameras recording chef's operation. The directions and positions of the coordinate systems of main ingredient containers 15 (Σᵥ₁, Σᵥ₂ . . . Σᵥₙ) are set that when any of the mechanical hands 16 holds any of the main ingredient containers 15, the coordinate system of this mechanical hand is superimposed upon the coordinate system of the respective main ingredient container 15. The directions and positions of the coordinate systems of the seasoning material containers 17 (Σ_{f1}, Σ_{f2} . . . Σ_{fu}) are set that when the cooking container 10 receives the seasoning material from any of the seasoning material containers 17, the coordinate system of the cooking container 10 is superimposed upon the coordinate system of the respective seasoning material container 17. The stove fire switch will be controlled by a computer program controlled motor.

FIG. 10 is the electrical circuit drawing of the recording system for recording a Chef's cooking process. As shown in FIGS. 1 and 10, cameras 1 are connected with image processing circuit boards 2. Said cameras 1 will send the images of the cooking process of the Chef through image processing circuit boards 2 to computer 3. The stove rotating switch 5 of the stove having a rotation sensor is connected with the first interface 9A (such as A/D circuit board). Said stove rotating switch 5 records the signals of the rotating angle (the strength of the fire) chosen by the Chef, and sends the signals through the first interface 9A to computer 3. The seasoning material containers 6 comprise electronic scales 7, and the changed amounts of the seasoning materials used by the Chef will be recorded by the electronic scales 7. These data will be sent through the first interface 9A to computer 3. The main ingredient containers 8 comprise ingredient sensors 12 (such as diode infrared transmitters) that are connected with the second interface 9B. Said ingredient sensors 12 will send signals representing the time when the main ingredients are put into the cooking container through the second interface 9B to computer 3. A simple program modular can be made according to the above data. According to the result of the above calculation, computer 3 having a ready-made program in addition to program modular will provide operation program imitating chef's movement when cooking each dish. The program can be adjusted if necessary according to the requirement of each occasion.

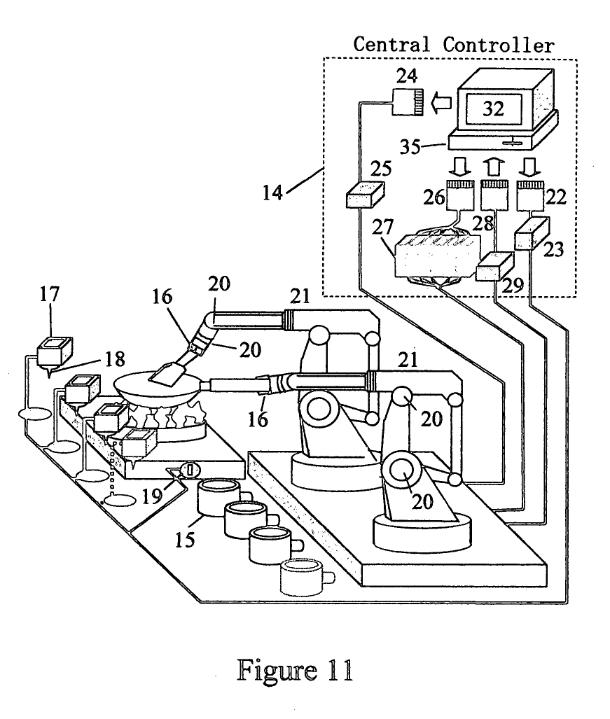

FIG. 11 is the electrical diagram of the mechanical operating system of the automatic cooking system. After the operation program of the automatic cooking system is inserted into computer 35 of the central controller, the system will be started. Computer 35 will send operation program's control signals for controlling the amounts of seasoning materials through pulse generating board 22 to stepping motor drives 23, and then the stepping motor drives 23 motivate the stepping motors of the program controlled funnel 18 of the seasoning material containers 17, and add the seasoning materials to the cooking container. Computer 35 will send the control signals of the operation program that control the strength of stove fire through pulse generating board 22 to respective stepping motor drive 23. The stepping motor drive 23 will control stepping motor of the program controlled stove rotating switch to control the strength of the fire. The operation program of the computer 35 will control mechanical hands 16 to grab main ingredient containers and pour out main ingredients. The control signals will be sent through pulse generating board 24 to stepping motor drives 25. The stepping motor drives 25 will control mechanical hands 16 to grab and hold main ingredient containers, cooking container, and shovel. The movements of each joint of the manipulators when accomplishing the cooking tasks are controlled by the computer. The computer sends control signals through a third interface 26 (such as A/D circuit board) to drivers 27. The drivers 27 will control the movement of the manipulators through the motors of each joint 20 to accomplish cooking tasks. The angle rotation signals of the manipulators' motor angle rotation transmitters will be amplified through amplifier 29 and send to counter board 28. The feedback signal of the movement of the manipulators will be sent to computer 35, in order to calibrate the movements of the manipulators. The manipulators of this system will be able to imitate the cooking process according the operation program.

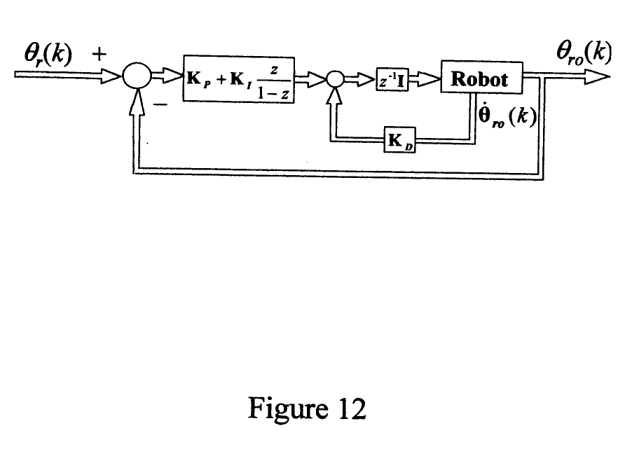

FIG. 12 is the manipulator control diagram, wherein θᵣ(k) is the target movement track of the right manipulator calculated from operation recording system (the output of FIG. 7), same is for the left manipulator. Said block diagram is the PID control diagram for ordinary controlled manipulators. Once the target track is known, each manipulator can be controlled as shown in FIG. 12. θᵣₒ(k) is the actual rotated angle of each joint of the manipulator, and θ′ᵣₒ(k) is the angle velocity of each joint of the manipulator.

As illustrated above, the essence of the present invention is to record and process the images of the movement of the chef when cooking (or real time process). Through calculations of the coordinate positions of three specified points on the cooking container and shovel used by the chef, the movement tracks of the cooking container and shovel when used by the chef to cook certain cuisine can be obtained (although the drawings and detailed description only referred to one cooking container and one shovel, the same method can be used for more than one cooking container and shovel). Then, the cooking program can be produced according to the amounts of main ingredients and seasoning materials added by the chef and the time the main ingredients and seasoning materials are added when cooking, the strength of the stove fire and the movement track of the cooking container and shovel. Furthermore, the manipulators of the mechanical operating system of the present invention will imitate the chef's cooking movements according the signals of the above program and produce the cuisines similar to what are produced by the chef. In addition, the method and system of the present invention can also be used partially. For example, recording system or mechanical operation system may be used as an independent system. Or, the mechanical operation system may be used as a supplemental device supporting chef's operation.

What is claimed is:

1. A method for using an automatic cooking system to simulate a cooking process for a dish by a famous chef, wherein the automatic cooking system comprises recording devices, an operation program and a mechanical cooking apparatus, the method comprising the steps of:
recording the cooking process by the chef and compiling the cooking process into computer-readable data;
inputting the computer-readable data into the operation program; and
using the operation program to operate the mechanical cooking apparatus to simulate the cooking process by the famous chef.

2. The method according to claim 1, wherein cooking ingredients, seasoning materials, cooking utensils and a stove are used in the cooking process, and the recording of the cooking process comprises the steps of:
recording the kinds and amounts of the ingredients and seasoning materials prepared by the chef;
recording the timing when the ingredients and seasoning materials are added by the chef;
recording the temperature and fire power of the stove and the timing of each adjustment of the stove; and
measuring movement tracks of the cooking utensils.

3. The method according to claim 1, wherein the mechanical cooking apparatus comprises:
two mechanical arms to add ingredients and seasoning materials to cooking utensils and to move the cooking utensils according to commands from the operation program; and
a stove controlling device to control the temperature and fire power of the stove according to commands from the operation program.

4. The method according to claim 2, wherein the movement tracks of the cooking utensils are measured by recording moving tracks of marked points on the utensils and through image processing by a computer.

5. The method according to claim 2, wherein the kinds and amounts of the ingredients and seasoning materials and the timing when the ingredients and seasoning materials are added are recorded by placing electronic scales under containers containing the ingredients and seasoning materials and send electronic signals through an interface transformer to a computer.

6. The method according to claim 2, wherein the fire power of the stove is recorded by an angle rotating transmitter that measures rotation angles of a rotating switch of the stove, and wherein the temperature of the stove is measured by a thermocouple thermometer.

7. A method for recording a cooking process for a dish by a famous chef, wherein cooking ingredients, seasoning materials, cooking utensils and a stove are used in the cooking process, the method comprising the steps of:
recording the kinds and amounts of the ingredients and seasoning materials prepared by the chef;
recording the timing when the ingredients and seasoning materials are added by the chef;
recording the temperature and fire power of the stove and the timing of each adjustment of the stove; and
measuring movement tracks of the cooking utensils.

8. The method according to claim 7, wherein the movement tracks of the cooking utensils are measured by recording moving tracks of marked points on the utensils and through image processing by a computer.

9. The method according to claim 7, wherein the kinds and amounts of the ingredients and seasoning materials and the timing when the ingredients and seasoning materials are added are recorded by placing electronic scales under containers containing the ingredients and seasoning materials and send electronic signals through A/D transformer to a computer.

10. The method according to claim 7, wherein the fire power of the stove is recorded by an angle rotating transmitter that measures rotation angles of a rotating switch of the stove, and wherein the temperature of the stove is measured by a thermocouple thermometer.

11. An automatic cooking method, which comprises the steps of:
recording kinds and amounts of main ingredients and seasoning materials prepared by a chef;
measuring movement tracks of cooking containers and shovels;
measuring the time when the main ingredients and seasoning materials are added by the chef and duration of the cooking;
recording and measuring adjustments by the chef of fire strength of a stove and time of the adjustments;
making an operation program of an automatic cooking system reflecting the cooking process of the chef according to measured data; and
installing said operation program to a central control unit of the automatic cooking system to simulate the cooking process of the chef.

12. The automatic cooking method as claimed in claim 11, wherein the movement tracks of said cooking containers and shovels are obtained by
recording the cooking process by at least one camera; and
obtaining moving paths of marked points of the cooking containers and shovels through image processing by a computer.

13. The automatic cooking method as claimed in claim 11, wherein the timing when the main ingredients are put into the cooking containers is obtained by measuring positions of main ingredient containers by ingredient sensors, wherein a computer treats the time when the main ingredient containers leave original positions as the time that the respective main ingredients are put into the cooking container.

14. The automatic cooking method as claimed in claim 11, wherein the amounts and kinds of the seasoning materials added by the chef are obtained by placing one electronic scale under each seasoning material container, wherein said electronic scales send electronic signals of the weight through a first interface to a computer, and wherein the timing when the seasoning materials are added is automatically recorded using a clock of the computer.

15. The automatic cooking method as claimed in claim 11, wherein the fire strength of the stove adjusted by the chef and time of the adjustments are recorded by a rotation sensor that measures rotation angles of a stove rotating switch adjusted by the chef, and wherein the time of the adjustments is automatically recorded by the computer when the switch of the stove is adjusted, whereas a temperature sensor is mounted on a cooking container to measure temperature of the cooking container.

16. An automatic cooking system, which comprises a recording system for recording operation processes by a chef, and a mechanical operating system that performs cooking tasks according to the operation processes recorded by said recording system, wherein the recording system comprises:
recording devices which record the kinds and amounts of main ingredients and seasoning materials prepared by the chef;
recording equipments which record the timing when the main ingredients and seasoning materials are added by the chef and the duration of the cooking;
track measuring devices which measure movement tracks of the cooking containers and shovels;
fire strength recording device that records and measures the adjustments made by the chef to the fire strength of a stove and the time of the adjustments; and
program processing equipment that makes an operation program of the automatic cooking system reflecting the cooking process of the chef according to measured data,
and wherein the mechanical operating system comprises:
a controller where the operation program is installed that is adapted to control the mechanical operating system according to the operation program;
at least one manipulator that is connected to the cooking containers and shovels, receives signals from said controller and is adapted to accomplish cooking tasks according to the operation program;
a fire strength controlling device that is adapted to control the fire strength of the stove according to the operation programs of said controller;
main ingredient and seasoning material supplying devices that are adapted to control the kinds, amounts and supply time of the main ingredients and seasoning materials according to signals received from the controller.

17. The automatic cooking system as claimed in claim 16, wherein the track measuring devices comprise cameras that are adapted to record the cooking process, and image recording and analysis devices that are adapted to measure the movement tracks of the cooking containers and shovels, wherein said track measuring devices are also used to record and analyze said mechanical operating system to automatically monitor an automatic cooking process and send an alarm signal when abnormal fire is detected and to automatically put out the abnormal fire.

18. The automatic cooking system as claimed in claim 16, wherein said seasoning material recording devices comprise electronic scales that are placed under seasoning material containers, and are connected to a first interface that conveys electronic signals from the electronic scales to a computer.

19. The automatic cooking system as claimed in claim 16, wherein said fire strength recording device comprises a rotation sensor that is adapted to measure a rotating angle of a stove rotating switch, and is connected to a first interface that sends signals from said rotation sensor to a computer.

20. The automatic cooking system as claimed in claim 16, wherein said manipulators comprise
a shovel holding arm that receives signals which reflect shovel holding action according to operation program from said controller and moves according to the signals; and
a cooking container holding arm that receives signals which reflect cooking container holding action according to the operation program from said controller and moves according to the signals.

21. The automatic cooking system as claimed in claim 16, wherein said fire strength controlling device of the stove is driven by a motor that is controlled by said controller.

22. The automatic cooking system as claimed in claim 16, wherein said seasoning material supplying devices are driven by a motor that is controlled by said controller.

23. The automatic cooking system as claimed in claim 16, wherein the cooking containers and shovels are adapted to be moved in any direction by said manipulators, and each joint of said manipulators is driven by a motor that is controlled by said controller.
